(19) United States
(12) Patent Application Publication
(10) Pub. No.: US 2022/0383216 A1
(43) Pub. Date: Dec. 1, 2022

(54) COMPUTER-BASED SYSTEMS FOR VALIDATING SCENARIO OBJECTS TO CALCULATE MARKET RISK

(71) Applicant: Wells Fargo Bank, N.A., San Francisco, CA (US)

(72) Inventors: Vijaya Malkapuram, Cresskill, NJ (US); Pekka A. Kauranen, Houston, TX (US); Ping Hu, Charlotte, NC (US); Edward Haag, Charlotte, NC (US); Ashu Joglekar, Riverside, CT (US)

(21) Appl. No.: 16/522,299

(22) Filed: Jul. 25, 2019

Related U.S. Application Data
(60) Provisional application No. 62/832,140, filed on Apr. 10, 2019.

(51) Int. Cl. G06Q 10/06; G06Q 30/02

(52) U.S. Cl. CPC G06Q 10/0635; G06Q 30/0201

(57) ABSTRACT

A system for verifying scenario objects is described. The system generates, based on a historical market data model, a scenario object that includes an adjustment to a current market data object. The system then verifies that the scenario object comprises a valid scenario object by verifying that the scenario object does not violate one or more arbitrage conditions when applied to the current market data object. Upon generating the valid scenario object, the system calculates an adjusted market data object based on the valid scenario object and the current market data object.

This application claims the benefit of U.S. Provisional Application Ser. No. 62/832,140, filed on Apr. 10, 2019, the entire content of which is incorporated herein by reference.

### TECHNICAL FIELD

The invention relates to computer-based systems configured to calculate capital requirements for market risk.

### BACKGROUND

Financial institutions, such as commercial and investment banks, manage financial assets for clients. Financial assets may be held in bank accounts, brokerage accounts, and other accounts that are managed by the financial institution. As part of the financial asset management, financial institutions calculate market risk (i.e., risk of loss) for the financial assets. Financial institutions must meet minimum capital requirements to cover the potential losses based on the calculated market risk, and report compliance with such minimum capital requirements to financial regulators.

### SUMMARY

In general, this disclosure describes a system configured to generate valid scenario objects used to calculate market risk for financial institutions. For the purposes of this disclosure, a scenario object comprises data having unique attributes and behavior that simulates market moves based on historical risk factor data. A valid scenario object is a scenario object that does not violate any mathematical rules or arbitrage conditions when applied to current market data. Pricing systems and other platforms may use scenario objects, as described herein, to adjust or “shock” current market data in order to calculate market risk (i.e., risk of loss), including value at risk (VaR) and expected shortfall (ES) as examples.

In some examples, according to the techniques described in this disclosure, the system is configured to verify that a scenario object is valid prior to applying the scenario object to a pricing system. In this way, the system is able to determine whether the scenario object violates one or more arbitrage conditions when applied to a current market data object before causing a failure at the pricing system or other platform. Once the system verifies that the scenario object is valid, the system calculates an adjusted market data object, which may be applied by the pricing system to calculate a Value at Risk (VaR), estimated shortfall (ES), or other market risk valuation for a financial institution. As such, by validating the scenario object prior to applying the scenario object to the current market data objects, the system may generate scenario objects that will not fail, ultimately saving processing resources during the market risk calculation process.

In additional examples, the system is configured to generate a scenario object according to one or more scenario expressions called from a software library and/or based on historical market data. Scenario expressions may provide a seamless way of modifying a time series for historical marker data, interacting with other systems to request or retrieve the necessary historical market data, as well as accessing software libraries of financial tools to produce more precise and accurate scenarios. For instance, the system may request the historical market data and manipulate the historical market data based on one or more received time series conditions. For example, the time series conditions may include inconsistencies or data missing from the time series for which the scenario object is intended to cover, and the system may correct or otherwise modify the time series using proxy data. The system may then generate the scenario object based on this manipulated historical market data. Using these scenario expressions, users may have finer control over the scenario object generation process, further ensuring that valid scenario objects are generated prior to any application in pricing systems.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating a process of generating valid scenarios to calculate and report market risk, in accordance with the techniques of this disclosure.

FIG. 2 is a conceptual diagram illustrating an example market risk calculation platform, in accordance with the techniques of this disclosure.

FIG. 3 is a conceptual diagram illustrating a system of gathering market data and generating valid scenarios for calculating an adjusted market data object for use by a pricing system, in accordance with the techniques of this disclosure.

FIG. 4 is a conceptual diagram illustrating an example scenario generation and value at risk (VaR) calculation process, in accordance with the techniques of this disclosure.

FIG. 5 is a conceptual diagram illustrating an example scenario evaluation process based on scenario expressions, in accordance with the techniques of this disclosure.

FIG. 6 is a conceptual diagram of an example return series for a stock value and a proxy calculation, in accordance with the techniques of this disclosure.

FIG. 7 is a conceptual diagram illustrating an example scenario evaluation process based on external scenario definitions, in accordance with the techniques of this disclosure.

FIG. 8 is a block diagram illustrating an example computing device that includes the market risk calculation platform from FIGS. 1 and 2, in accordance with the techniques of this disclosure.

FIG. 9 is a flowchart illustrating a first example operation of a computing device to generate valid scenarios to calculate and report market risk, in accordance with the techniques of this disclosure.

FIG. 10 is a flowchart illustrating a second example operation of a computing device to generate valid scenarios to calculate and report market risk, in accordance with the techniques of this disclosure.

### DETAILED DESCRIPTION

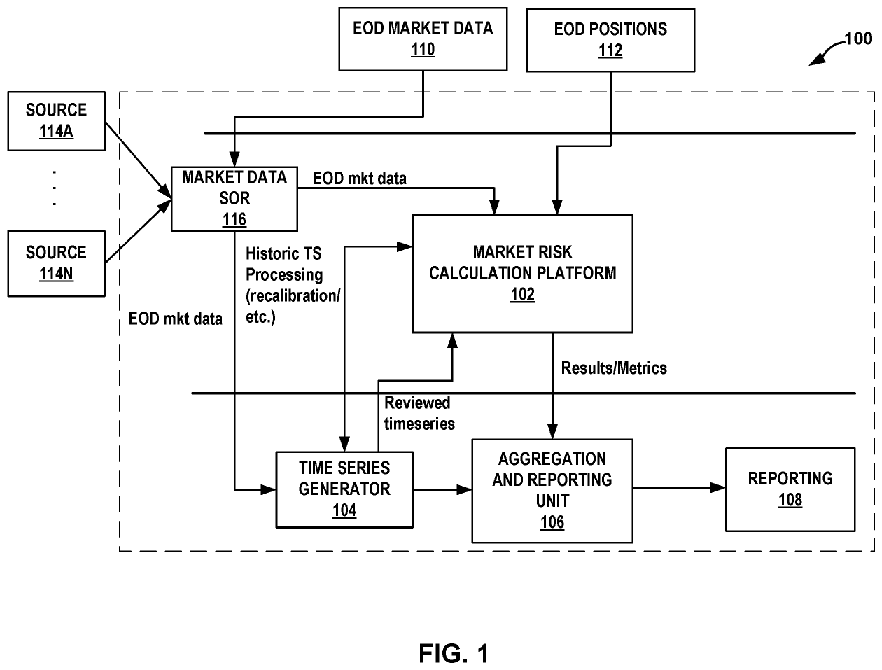

FIG. 1 is a conceptual diagram illustrating a process of generating valid scenarios to calculate and report market risk, in accordance with the techniques of this disclosure. Financial institutions, such as commercial and investment banks, manage financial assets for clients. As part of the financial asset management, financial institutions calculate market risk (i.e., risk of loss) for the financial assets. Financial institutions must meet minimum capital requirements to cover the potential losses based on the calculated market risk, and report compliance with such minimum capital requirements to financial regulators.

As illustrated in FIG. 1, system 100 includes market risk calculation platform 102, time series generator 104, and aggregation and reporting unit 106 used to calculate and report market risk, including value at risk (VaR) and expected shortfall (ES) as examples. In the example of FIG. 1, market risk calculation platform 102 is configured to generate valid scenario objects used to adjust or “shock” current market data in order to calculate the market risk. In some examples, market risk calculation platform 102 may generate the valid scenario objects according to one or more scenario expressions. Scenario expressions include descriptions and conditions for how to compute various scenarios.

System 100 may be implemented on a centralized or distributed network of computing devices included in a financial institution. As illustrated, system 100 may calculate and report market risk based on end-of-day (EOD) input received from other departments of the financial institution (e.g., EOD market data 110 and EOD positions 112) and based on external market data received from financial sources 114A-114N (collectively, “sources 114”), e.g., Reuters, Bloomberg terminals (BBG), and the like.

In this disclosure, techniques are described for generating valid scenario objects that do not violate arbitrage conditions when applied to a current market data object. When scenario objects are initially generated, there are many ways in which the scenario object may be invalid, incomplete, or otherwise ineffective to make accurate predictions for future pricing models.

Once the respective platform generates scenario objects, the system may utilize various instrument models, pricers, decomposers, and/or compute tasks to receive the scenario objects as inputs and produce the reports that include the market risk values. This is a very computationally heavy process, but various aspects of the scenario objects may cause portions of the market risk value calculations to be based on unrealistic or impossible variables. As such, if a scenario object causes portions of the market risk value calculations to be based on unrealistic or impossible variables, the system may waste time and processing power by utilizing the improper scenario objects.

The techniques described herein include scenario generation according to scenario expressions that enable correction or other modification of heterogeneous or missing data within a time series of historical market data used to generate scenario objects. The techniques described herein also include a preliminary validation process to ensure that the generated scenario object, when applied to a current market data object, produces valid data that does not violate arbitrage conditions and, therefore, provides accurate and useful data to be used in various risk assessment pricing systems.

In the example of FIG. 1, system 100 may gather end of day (EOD) market data 110 and information from various sources 114 (e.g., various stock exchanges) to produce combined system of record (SOR) market data 116. Market risk calculation platform 102 may also receive historical time series from time series generator 104, as well as any particular end of day (EOD) positions 112 that may influence potential scenarios on a company preference basis. In the most basic examples, market risk calculation platform 102 receives market data, positions, and time series information as inputs to the scenario generation process described herein. Various sources 114 may generate the market data received by market risk calculation platform 102 as an input. System 100 may also generate SOR market data 116 for use as an input to market risk calculation platform 102. Time series generator 104 may generate the time series information to be used as an input by market risk calculation platform. Market risk calculation platform may also receive positions as inputs, such as EOD positions 112.

Market risk calculation platform 102 may combine each of these sets of information into a single historical market data object, or a historical market data model, in order to generate scenario objects for a particular time series received from time series generator 104 in accordance with the techniques of this disclosure. Market risk calculation platform 102 may apply the generated scenario object to current market data to produce an adjusted market data object, which market risk calculation platform 102 sends to aggregation and reporting unit 106. Aggregation and reporting unit 106 analyzes the adjusted market data object to assess the current market risk. Reporting module 108 then sends the current market risk to the appropriate regulatory bodies.

In some examples, the techniques include a scenario generation methodology that includes a verification step to determine that a scenario is valid, i.e., does not violate arbitrage conditions, prior to application of the scenario to a current market data object and use by pricing systems. In other examples, the techniques include an expression based flexible scenario generator in which complex rules for scenario generation may be modeled, modified, and input using a set of relatively simple expressions. The valid scenario objects may be generated using a Quant library, i.e., a software library of financial instrument evaluation tools, included within the market risk calculation platform 102. For example, the scenario expressions used to generate a given scenario object may be called from compute modules which may utilize the Quant library.

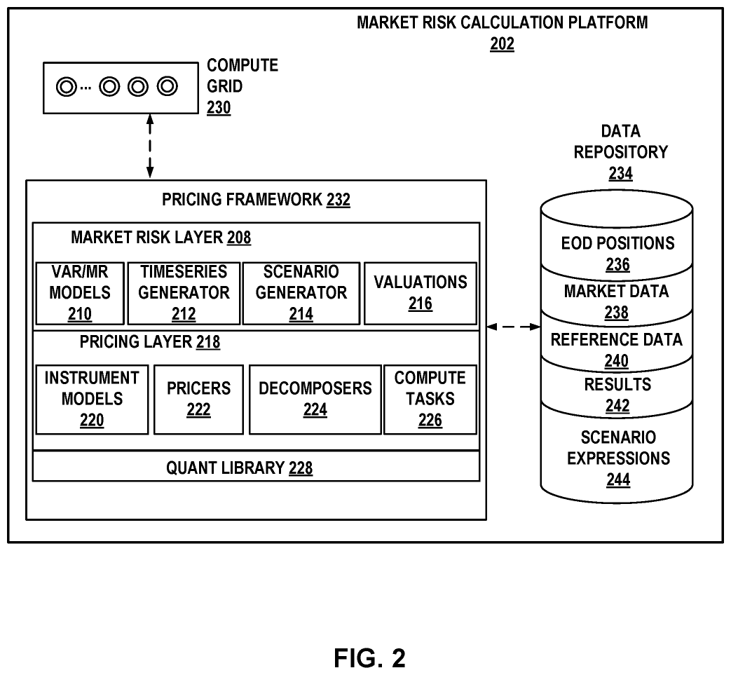

FIG. 2 is a conceptual diagram illustrating an example of a market risk calculation platform in further detail. For instance, market risk calculation platform 202 is an example of market risk calculation platform 102 of FIG. 1. Market risk calculation platform 202 is only one such example, and other examples of market risk calculation platform 102 may include additional components or fewer components. For instance, market risk calculation platform 202 may not include data repository 234, and may instead receive the data stored in a data repository from an outside source.

Data repository 234 may be a long- or short-term memory that is configured to store one or more different sets of data to be used in the scenario generation and validation techniques described herein. For instance, in the example of FIG. 2, data repository 234 may store EOD positions 236, market data 238, reference data 240, pricing results 242, and scenario expressions 244. Pricing framework 232 may reference data stored in data repository 234 throughout the execution of the scenario generation and validation techniques described herein.

In the example of FIG. 2, market risk calculation platform 202 includes compute grid 230, pricing framework 232, and data repository 234. Market risk calculation platform 202 may utilize these components in the scenario object generation and verification techniques described herein. In the example of FIG. 2, compute grid 230 may be a distributed set of processors, with each processor in the distributed set of processors being tasked with executing one or more modules in pricing framework 232 to perform at least a portion of the scenario generation and verification techniques described herein. In other examples, computing grid 230 may instead be only a single processor.

Pricing framework 232 may include multiple layers, with each layer including various models and modules executable by compute grid 230 to perform one or more of the techniques described herein. For instance, pricing framework 232 may include market risk layer 208, pricing layer 218, and quant library 228. Market risk layer 208 may leverage quant library 228 to perform the general techniques of generating and validating the scenario objects described herein. Once scenario objects are generated and validated, pricing layer 218 may utilize instrument models 220, pricers 222, decomposers 224, and compute tasks 226 to receive the scenario objects as inputs and produce the reports that are sent to an aggregation and reporting unit.

Market risk layer 208 may include VaR/MR models 210, time series generator 212, scenario generator 214, and valuations 216. In some instances, market risk layer 208 may generate time series internally using time series generator 212. In other instances, market risk layer 212 may communicate with a time series generator to receive various time series. Scenario generator 214 may perform the various scenario generation and validation techniques described herein, referencing VaR/MR models 210, time series generator 212, and valuations 216 to obtain the data necessary to compute such scenario object. Scenario generator 214 may send the generated valid scenario objects to pricing layer 218.

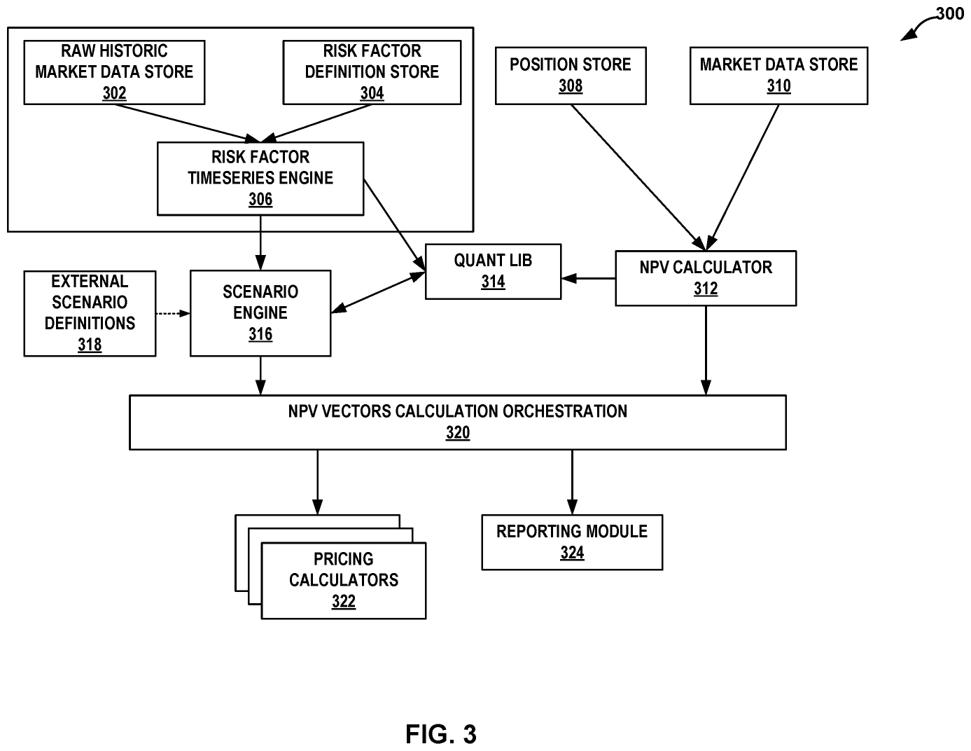

FIG. 3 is a conceptual diagram illustrating a system 300 of gathering market data and generating valid scenarios for calculating an adjusted market data object for use by a pricing system, in accordance with the techniques of this disclosure. In the example of FIG. 3, system 300 includes pricing components, including position store 308, market data store 310, and net present value (“NPV”) calculator 312. System 300 also includes risk specific components, which include raw historic market data store 302, risk factor definition store 304, risk factor time series engine 306, external scenario definitions 318, scenario engine 316, and NPV vectors calculation orchestration 320. System 300 may use the output from the pricing components and the risk specific components as inputs into additional pricing calculators 322. Examples of pricing calculators include a VaR calculator, a management reporting module, an ES calculator, a stress/comprehensive capital analysis and review (“CCAR”) calculator, a standard initial margin model (“SIMM”) sensitivity calculator, a back testing calculator, an FRTB SA sensitivity calculator, and a PLA calculator. System 300 may also use the output from the pricing components and risk specific components as inputs into reporting module 324, which may generate and send reports to the necessary systems. System 300 also includes Quant library 314, as defined throughout this disclosure, which assists scenario engine 316 in creating and validating scenario objects.

Risk factor definition store 304 contains expressions for proxy time series, derived time series, and other raw time series stitching mechanisms. Risk factor time series engine 306 accesses the raw time series in raw historic market data store 302 and risk factor definitions in risk factor definition store 304 to compute target risk factor time series inclusive of any proxy or otherwise derivative time series. Scenario engine 316 takes today's market data and the target risk factor time series, and potentially external scenario definitions 318, to generate scenarios. NPV calculation 312 takes a trade and a scenario and computes an NPV, applying the scenario in question. NPV vectors calculation orchestration 320 then orchestrates the generation of NPV vectors across different lookback time periods and risk horizons.

The components of the enhanced VaR solution are as follows. A calculation framework includes modules involved in scenario generation, pricing, profit and loss (“PNL”) vectors generation, aggregation, and risk measure calculations. A time series management framework includes modules involved in time series construction. The techniques described herein may analyze heterogeneous representations of available raw data time series across different historical time periods, which is the process described herein as “time series construction.” The techniques described herein may also provide support for robust auditable data management processes, i.e. data quality checks and remediation, gap filling, etc. Further, the techniques described herein may provide support for robust and auditable data re-computation processes when models or underlying data change, thereby necessitating the change in the historical data, which is the process described herein as “time series recalibration.” Further, a time series management framework includes modules involved in risk factor time series modeling, time series data quality processes, monitoring, maintenance, reporting, etc. The use cases for the solution described herein include VaR, stress testing/CCAR, risk reporting, Greeks calculations (e.g. FRTB SBA, SIMM, etc.), VaR backtesting, profit and loss attribution (“PLA”), What-if, etc.

The expression based scenario generation techniques described herein may make the scenario generation process more transparent to users of system 300, such as various financial institutions or individuals wishing to calculate VaR for various assets, by enabling the rules for the scenario generation to be modified and defined by the users themselves. More specifically, the format of the scenario expressions enables the users to configure the scenarios.

The expression based scenario generation techniques manage historical market data 302 based on time series generated by risk factor time series engine 306. The scenario expressions may define how the scenarios are generated, including how the scenarios incorporate proxies, risk horizon, relative returns, risk factor time series, etc. The scenario expressions may also set default parameters or instructions for averages of past data if current data is not available. For instance, if historical market data 302 is only available for the past two years for a company with a relatively recent initial public offering (IPO), the scenario expressions may define use of market averages in market data store 310, e.g., SPX or IXT, as proxy data in order to generate a more accurate scenario object. In essence, the techniques described herein enable risk modeling users to manipulate the scenario expressions directly or even create the scenario expressions, which may be stored in and interact with other tools in Quant library 314, i.e., the software library of financial instrument evaluation tools. The expression language may be used to manipulate the time series to specify different indices that can be used when historical market data is not present or to fill in interest rate periods. These expressions may enable any data manipulations or modifications to be independently managed by the risk modeling users without going through other teams in the financial institution.

In accordance with the techniques described herein, the scenario expressions may also specify the desired type of returns, such as absolute returns, relative returns, or custom returns. Scenario expressions may provide a seamless way of manipulating the time series, interacting with other systems to request or retrieve the necessary historical market data, as well as accessing software libraries of financial tools to produce more precise and accurate scenarios. The expression-based scenario generation techniques may be used to generate particular scenario objects, dynamically construct a time series, and interact with the pricing and quant libraries, among other things.

The valid scenario generation techniques described herein may provide the ability to validate generated scenarios prior to application to a current market data object and pricing systems. These scenarios may be received from outside devices, generated within scenario engine 316, or generated by some other component in the overall system. For instance, before dedicating a large amount of processing resources to applying scenario objects to market data objects for use by a pricing system, scenario engine 316 may check that the scenario object does not violate one or more arbitrage conditions. If the scenario object violates arbitrage conditions, the resulting output from the pricing system would be unrealistic and would not be valuable for use in any forecasts (e.g., the forecasts performed by calculators 322). As such, by validating the scenario object prior to applying the scenario object to the market data objects, scenario engine 316 may generate scenario objects that will not fail, ultimately saving processing resources.

If there are inaccuracies or errors due to the scenario object, scenario engine 316 may have to go through time consuming recalculations, which leads to costly inefficiency. In conventional systems, it is unknown how the shock of a scenario object may interact with the current pricing market or how it may affect particular market variables until it is applied to a current market data object (MDO) at the time of pricing. Scenario engine 316 uses quant library 314 and a historical market data object produced by risk factor time series engine 306 to compute a “valid” scenario object before pricing. This conceptually tests the application of the shock of the scenario object to the current MDO before pricing to ensure that the output is going to be correct and valuable. Applying invalid scenario objects could result in scenarios that are unrealistic, such as negative stock prices for market variables. According to the techniques of this disclosure, before the full pricing is completed, scenario engine 316 may detect these anomalies to determine that errors would arise from the combination of MDOs and shocks, and take appropriate steps to ensure generation of valid scenario objects.

Scenario engine 316 may also generate metadata that describes what happened during the scenario object validation process and what errors were encountered so that the system may make whatever changes are needed to the overall model to produce a valid scenario. During validation, scenario engine 316 may extract dependency information from the current MDO to determine the relationships between particular variables that may be affected by the shock of the scenario object. In this way, the scenario object may group the variables and their interdependencies. After the verification step, NPV vectors calculation orchestration 320 may apply the valid scenario to the current MDO to calculate an adjusted or shocked MDO for use by the individual pricing models. For example, a VaR calculator of pricing calculators 322 may use the adjusted MDO to calculate the necessary VaR information to determine market risk and minimum capital requirements to cover the potential losses based on the market risk.

In accordance with the techniques described herein, scenario engine 316 generates, based on a historical market data model, a scenario object that includes an adjustment to a current market data object. Scenario engine 316 verifies that the scenario object comprises a valid scenario object by determining that the scenario object does not violate one or more arbitrage conditions when applied to the current market data object. Upon generating the valid scenario object, scenario engine 316 calculates an adjusted market data object based on the valid scenario object and the current market data object such that the market risk calculation platform ensures resiliency of the adjusted market data object during pricing. In this way, scenario engine 316 improves resiliency in value at risk calculations, greatly improving the quality of the value at risk process and saving processing cost on operating procedures and reruns of the scenario object generation.

Further, in accordance with the techniques described here, scenario engine 316 generates, according to one or more scenario expressions executed by scenario engine 316, a scenario object that includes an adjustment to a current market data object. In generating the scenario object according to the one or more scenario expressions, scenario engine 316 requests historical market data from a data repository. Scenario engine 316 then receives one or more time series conditions. Scenario engine 316 manipulates one or more characteristics of the historical market data based on the one or more time series conditions and generates, based on the manipulated historical market data, the scenario object. Scenario engine 316 then applies the scenario object to the current market data object to calculate an adjusted market data object. In this way, scenario engine 316 provides an effective way of managing multiple complex steps and operations in a simplistic expression language. As such, through the use of scenario engine 316, the overall system may save costs in the development, enhancement, and troubleshooting stages. Further, scenario engine 316 may make the workflow management more efficient and empower users by providing flexibility and control over timeseries construction and scenario generation.

With the evolution of regulatory and industry standards in measuring risk and capital, the techniques described herein provide methodologies to meet these new requirements. In particular, Fundamental Review of Trading Book's (FRTB) Internal Models Approach (IMA) may use significantly higher compute capacity, requiring higher quality data, modeling, and justifiable proxy management in generating VaR/Expected Shortfall (ES) (which are inputs into capital calculations).

The aim of the techniques described herein is to address the enhanced VaR requirements. Additionally, the techniques described herein provide consistency of pricing (e.g., such as pricing with front office), flexibility and auditability of time-series construction, resiliency, consistency, auditability, and robustness of scenario generation, scalability and speed of pricing to achieve the revaluation requirements of FRTB IMA, and transparency across all steps of the calculation.

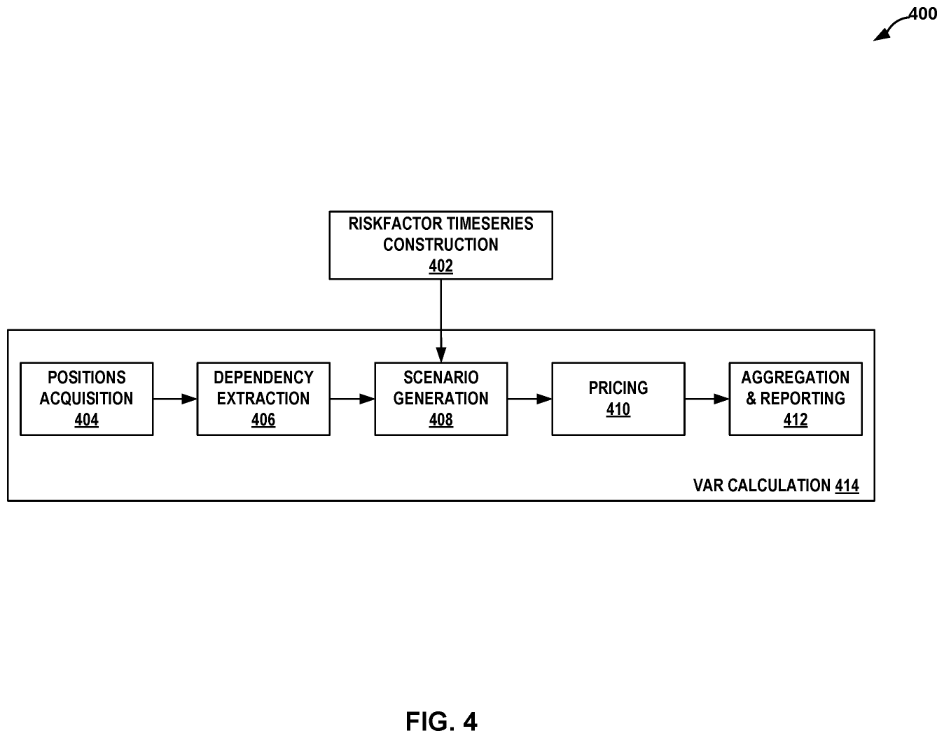

FIG. 4 is a conceptual diagram illustrating an example scenario generation and value at risk (VaR) calculation process 414, in accordance with the techniques of this disclosure. The individual steps involved in the “VaR Calculation 414” section are depicted in FIG. 4. If risk factors are available via risk factor time series construction 402, then the VaR calculation 414 may follow as below. In other examples, scenario generation may be performed separately and fed into VAR calculation 414.

Common design considerations for VAR calculation 414 include desiring the risk pricing to be as consistent with various pricing programs, such as the front office programs, as possible, including having the same EOD positions, EOD configuration objects, and EOD baseline market data. Additionally, it is desirable to use the same quant library pricers whenever possible. When proxy risk pricers are used, VAR calculation 414 strives for as much consistency as practicable. Finally, scenario generation 408 from risk factor time series construction 402 may be done by the quant libraries to achieve consistent valuation results.

The EOD positions described above may be determined in the step of position acquisition 404. These positions are typically defined at the company level. As such, positions acquisition 404 may be relatively more static as compared to the remainder of VaR calculation 414, as the market data is likely to be more volatile than the company's positions.

The reason for computing dependencies in dependency extraction 406 on a per instrument basis is to minimize the number of recalculations needed in PNL vector computation. For instance, when only commodity risk factors are shocked (e.g. for FRTB), the platform may not re-compute NPVs for rates instruments.

Pricers in the market risk calculation platform may be capable of producing their market data dependencies, in the form of a list of Market Data Objects (“MDOs”). Dependency extraction 406 may extract these dependencies from the MDOs. For example, for a U.S. Dollars (“USD”) Fixed/Float swap dependency extraction, pseudo-code for this extraction may include:
swapPricer.getMDODeps(swapInst)=>{“YC.USD.Libor.3M”, “YC.USD.OIS”}
   Dependency names (e.g. “YC.USD.Libor.3M”) may follow a division-wide name taxonomy.

Scenario generation 408 simulates market moves based on historical risk factor data. These scenarios are used to quantify PNL impact on the firm's positions. Further, the methodology of scenario generation 408 is a factor in determining the quality of VaR, as it directly impacts the PNL generated by the underlying pricing models.

Currently, direct application of scenarios to MDOs may lead to failures and inaccuracies in pricing 410 due to the introduction of arbitrage conditions and correcting for these at pricing time leads to additional problems. The techniques described herein may correct the input scenarios before pricing to minimize arbitrage violations. The goal should be to make minimum changes possible to correct the arbitrage violation. For instance, if the application scenario objects leads to the generation of a negative interest rate within the calculations, scenario generation 408 may adjust the data used to generate the scenario object just enough such that a non-negative interest rate is always used in the VaR calculation, without making additional changes once each arbitrage condition is satisfied during the VaR calculation.

In some examples, scenario generation 408 and consumption during pricing 410 and aggregation and reporting 412 are bifurcated between the market risk system and multiple pricing systems. In such examples, the techniques described herein may address the complications associated with such a bifurcation. In addition, in conventional systems, any corrections to the scenarios happen at pricing time within each individual pricer once a scenario failure is detected by the individual pricer during the application of the scenario. Due to corrections to scenarios at pricing 410, there may be no transparency on the corrections made, and no transparency to what the applied shocks were. Pricing 410 may also include inaccuracy in numerical Greeks computation, and there may be discrepancies in VaR and stress results that are hard to explain. Pricing 410 may not have the ability to use best-in-class arbitrage checking algorithms due to the impact those algorithms may have on pricing performance. Further, hard failures can occur with some inputs, such as those with large market moves. Since scenario corrections happen in individual pricers, the same scenario may be applied differently for different instruments. The user has no transparency to these effects.

Further, there may be hidden errors in the VaR process due to the bifurcation of scenario generation and consumption, such as potentially invalid/inconsistent scenarios generated with no checks on their correctness/validity. For instance, for the same scenario, pricing 410 could fail for some positions and succeed for others (with or without corrections). Pricing 410 may also have operational issues, such as valuation failures in VaR, stress, and CCAR calculations. These failures necessitate complicated process logic to deal with and make the VaR process unnecessarily opaque and complicated. Further, when a pricing fails due to a certain shock/shift and a different shift is applied, the information on the realized shifts is not readily apparent and additional tooling is warranted in several modules. Difficulties in investigations and root cause analysis with multiple points of failure.

In development, there may be longer turnaround times for any changes or enhancements made to the algorithms due to requiring multiple development teams and the difficult deployment coordination. There may also be difficulty in debugging and troubleshooting.

Risk factor time series are available to the scenario generation 408. This assumes all risk factor derivations and calibrations were processed to yield the target “derived” time series. The risk factor time series construction 402 may use the same expression framework as scenario generation 408. For instance, today's market data objects (MDO_{Today}) are available. Each risk factor is explicitly and unambiguously defined by market risk officers (“MRO”) and market risk analytics (“MRA”) (e.g. representation and granularity), which may be jointly referred to as “market risk model users”. These risk factors should conform to the market data taxonomy specifications

To overcome the issues from described above, the techniques described herein include a new approach for scenario definition and generation. In accordance with the techniques described herein, scenario generation may happen in the Quant library. This may remove loosely coupled systems handshakes, making the system more robust, transparent, and easier to debug. Scenario generators may also take, as inputs, today's market data along with historical data. This enables the Quant library authors to ensure the validity/correctness of the shocks. It may be easy to produce any adjustments and realized shifts as an output from this step providing, transparency to MROs and others. The model users may have the ability to control and configure how these quant functions are wired together. This is accomplished via scenario expressions.

A scenario is a shock to current market data, e.g. “move spot 1%”. More technically, a scenario is an object that can be applied to a valid market data object producing another valid market data object. Since the scenario object is generic enough to be used in multiple use cases (e.g. VaR, CCAR, Greeks computation), where and how scenarios are generated may vary. For VaR, scenario generation 408 happens in dedicated historical scenario generation functions that take as inputs historical market data to produce the scenarios.

In scenario application, shifts are always applied to the current market data. The shifted market data is then an input into pricing 410. This process is uniform for all use cases (Greeks, VaR, CCAR, etc.). In accordance with the techniques described herein, a scenario expression describes an algorithm definition for how to compute scenarios. The format may enable users to configure scenarios.

In accordance to the techniques described herein, scenarios are specified by scenario expressions. Here is a high level example of such a scenario expression that defines that the returns of the scenario should be relative returns and that today's MDO is to be used in the scenario. Note that these expressions are meant to be user definable:
SCENARIO.XYZ.SPOT {RETURN FUNCTION.EQSPOT.SCENARIOGEN.RELATIVE_(RETURN[XYZ],XYZ[today])};

These expressions may define how all scenarios are generated, incorporating proxies, risk horizon, relative returns vs. absolute differences, other transformations of risk factor time series, etc. This entire process may be akin to a structured set of data transformations that is transparent, auditable and repeatable.

Functions to achieve these data transformations are produced in the Quant library. One class of these expressions are “scenario generator functions”, which are responsible for generating the actual scenario objects (given current MDOs and historical time series). To avoid the issues caused by the bifurcation of scenario generation and consumption in the current implementation, necessary and minimum corrections may be made during the scenario object creation so to minimize pricing failures. In addition to the valid scenario outputs, all the corrections (“errors”) are tracked, with corresponding human-readable information on why they are made (“meta-data”). The actual creation of the scenario objects occurs at VaR run time, based on scenario expressions. This avoids accidentally stale or inconsistent scenarios caused by corrections to input data in a system without automatic dependency management.

In the techniques described herein, the Quant library may generate scenarios, as the Quant library (also referred to as the software library) is the only consumer of these Scenario Objects. However, this design does not immediately make the quant library the only producer. See the table below:

TABLE 1

| Computation | Scenario Producer | Scenario Consumer |
|---|---|---|
| Greeks | Quant lib | Quant lib |
| CVA/PFE | Quant lib | Quant lib |
| VaR | Quant lib | Quant lib |
| CCAR/Stress | External | Quant lib |
| Trader Slides | External | Quant lib |

As the above table indicates, definitions for trader and CCAR/stress scenarios are defined externally, but the Quant lib still is the only consumer. The techniques described herein may achieve a design where the Quant library is the only producer of scenarios, reaping the benefits of a high level of consistency and robustness. Using a new concept called External Scenario Definition (“ESD”) that defines a scenario, but cannot be directly applied to a market data object, the Quant library may generate the scenarios based on these definitions so that the Quant library can modify the output enough so that it is arbitrage free. The External Scenario Definitions may correspond to current Scenario Definitions produced by Risk systems. The scenario objects correspond to realized shifts.

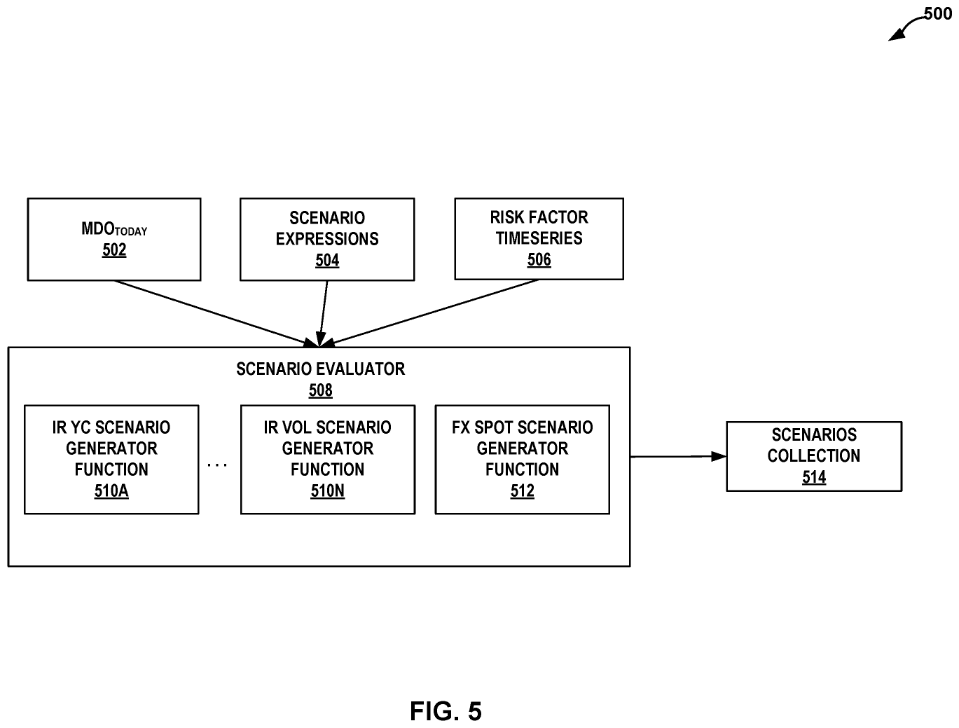

FIG. 5 is a conceptual diagram illustrating an example scenario evaluation process 500, in accordance with the techniques of this disclosure. The example of FIG. 5 depicts the orchestration of data and algorithms for scenario generation using scenario expressions, or user provided sets of directives on how the scenarios should be generated. These expressions may be defined and managed by market risk model users. Primitives available to these expressions belong to one of three different types: Data (e.g., the raw time series data 506 maintained in a time series database), predefined variables with values coming from either configuration contexts (e.g. RISK_HORIZON) or from the algorithm's previous steps (e.g. MDO 502), or functions (e.g., produced by pricing programs and risk analytics quants and exposed to scenario evaluator 508 (described below) and scenario expressions 504).

At scenario evaluation time, there are inputs that come from other sources, such as MDO 502 dependencies to determine which scenario sets to generate. These are sourced from pricers that natively produce this data.

Scenario evaluator 508 creates scenario objects taking MDO 502, scenario expressions 504, and risk factor time series 506 as inputs (as depicted in FIG. 5). Scenario expressions 504 are a set of directives to scenario evaluator 508 on how to compute the scenario object for a risk factor given two historical data snapshots and today's market data. Each MDO 502 is assumed to have a scenario expression 504 defined and maintained for it by the MRO. There may be a system (e.g., including a graphical user interface and a data store) to maintain these expressions. Furthermore, these expressions may be available to the market risk calculation platform. Scenario evaluator 508 may parse these expressions, source the inputs, and delegate the processing to the appropriate scenario generator function 510A-510N or 512. The output may be a collection of scenario objects 514.

An example scenario generation process for VaR calculations is outlined below. In this example, it may be assumed that a rates MRO is responsible for maintaining the scenario expression for this example. The platform may model scenarios based on 13 par point risk factors. In addition, the platform may model this MDO's risk based on relative shifts. The 13 par point risk factors may be available as follows, ranging in a time series from two weeks to thirty years:
RISKFACTOR.YC.USD.LIBOR.3M.PAR.2W
RISKFACTOR.YC.USD.LIBOR.3M.PAR.1M
RISKFACTOR.YC.USD.LIBOR.3M.PAR.3M
RISKFACTOR.YC.USD.LIBOR.3M.PAR.6M
RISKFACTOR.YC.USD.LIBOR.3M.PAR.1Y
RISKFACTOR.YC.USD.LIBOR.3M.PAR.2Y
RISKFACTOR.YC.USD.LIBOR.3M.PAR.3Y
RISKFACTOR.YC.USD.LIBOR.3M.PAR.5Y
RISKFACTOR.YC.USD.LIBOR.3M.PAR.7Y
RISKFACTOR.YC.USD.LIBOR.3M.PAR.10Y
RISKFACTOR.YC.USD.LIBOR.3M.PAR.15Y
RISKFACTOR.YC.USD.LIBOR.3M.PAR.20Y
RISKFACTOR.YC.USD.LIBOR.3M.PAR.30Y

For this example, scenario evaluator 508 may complete the following modeling steps. As the expressions operate on and produce time series, the modeling goal is to produce an expression that produces a target time series of scenarios. To generate a return series from the risk factors with relative return values, the MRO would use the following expressions for each of the time series defined above:
R1=RELATIVE RETURN

### (RISKFACTOR.YC.USD.LIBOR.3M.PAR.2W,#RISK HORIZON);

R2=RELATIVE RETURN

### (RISKFACTOR.YC.USD.LIBOR.3M.PAR.1M,#RISK HORIZON);

R13=RELATIVE RETURN
(RISKFACTOR.YC.USD.LIBOR.3M.PAR.30Y,#RISK HORIZON);

In these expressions, ‘RELATIVE_RETURN’ is a predefined function that takes a time series and a risk horizon and generates a calculated return series. #RISK_HORIZON is a configured risk horizon parameter usually set at 1 day, but is also ad-hoc configurable to another value. R1 etc. are temporary parameters to which the resulting series are assigned so they can be used in the next step described below.

To generate the time series of scenarios with relative returns and for each of the time series defined above, the MRO may use the following expression:
FUNCTION.YC.SCENARIOGEN.PAR.RELATIVE(YC.USD.LIBOR.3M[#TODAY], “2W”, R1, “1M”, R2, . . . , “30Y”, R13);

This assumes that all time series will be named and stored in a time series database.

For example, the above assumes the existence of
RISKFACTOR.YC.USD.LIBOR.3M.PAR.2W
   as a named time series for the 2w tenor point on the libor 3M curve (e.g., over a span of two weeks).

The scenario series definitions would also be saved following a structured naming schema. The expressions from the above modeling steps in this example may be saved under the following series name: SCENARIOS.YC.USD.LIBOR.3M.PAR. The complete expression set for YC.USD.LIBOR.3M curve may be as follows:

```
SCENARIOS.YC.USD.LIBOR.3M.PAR = {
  R1=RELATIVE_RETURN
  (RISKFACTOR.YC.USD.LIBOR.3M.PAR.2W,#RISK_HORIZON);
  R2=RELATIVE_RETURN
  (RISKFACTOR.YC.USD.LIBOR.3M.PAR.1M,#RISK_HORIZON);
...
  R13=RELATIVE_RETURN
  (RISKFACTOR.YC.USD.LIBOR.3M.PAR.30Y,#RISK_HORIZON);
  FUNCTION.YC.SCENARIOGEN.PAR.RELATIVE
  (YC.USD.LIBOR.3M[#TODAY],“2W”, R1, “1M”, R2, ... , “30Y”,
  R13);
}
```

At the time of evaluating the overall VaR algorithm, the scenario series SCENARIOS.YC.USD.LIBOR.3M.PAR is requested when processing instruments depending on YC.USD.LIBOR.3M. Scenario evaluator 508 may recursively evaluate the expression definition described above to create the series of Scenario objects for use in the VaR algorithm. This evaluation intuitively boils down to the following steps:
#RISK HORIZON and #TODAY: Configuration variables Fetch each risk factor time series referred to in the entries (i.e.

RISKFACTOR.YC.USD.LIBOR.3M.PAR.2W, . . . RISKFACTOR.YC.USD.LIBOR.3M.PAR.30Y)

For each risk factor time series, the platform may fetch market data, apply shifts, and generate scenarios. The following code snippet may be one example of the executed to generate such scenarios:

```
todaysUSDLiborCurve =
fetchMarketData(“YC.USD.LIBOR.3M”,#TODAY);
for each scenarioDate in riskfactor_timeseries.dates:
  ShockReturn returnValue = RETURNS(
  getTimeseriesValue(riskfactor_timeseries, scenarioDate),
  getTimeseriesValue(riskfactor_timeseries,scenarioDate−
  #RISK_HORIZON));
  Scenario IRYCScenario =
  FUNCTION.YC.SCENARIOGEN.PAR.RELATIVE(
  return Value,todaysUSDLiborCurve);
  scenarioCollection.add(IRYCScenario);
  return scenarioCollection;
```

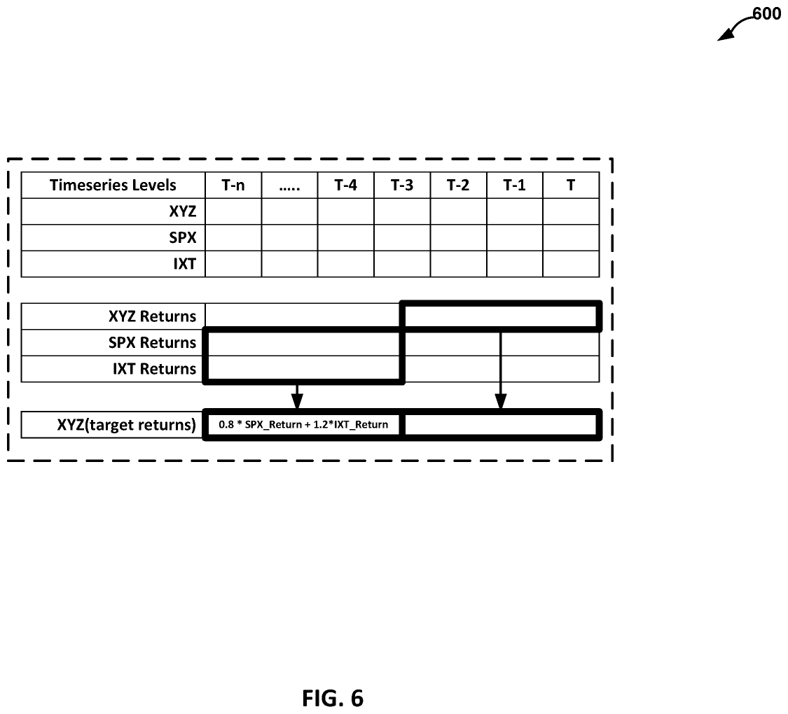

FIG. 6 is a conceptual diagram of an example return series 600 for a stock value and a proxy calculation, in accordance with the techniques of this disclosure. Return series 600 may be generated by a more complex expression including a proxy for time periods where the actual company's information is unavailable. The example of FIG. 6 an example of derived returns for a stock value for a company (e.g., XYZ). Below is an example of such an expression. Here, the platform may use XYZ symbol where the returns themselves are to be derived from the returns of SPX and IXT (i.e. a proxy) for a period of time and use the XYZ time series returns where available. Specifically, SPX and IXT values may be used as a proxy for the XYZ values for earlier years when the XYZ values are unavailable, and the XYZ values themselves are used for time periods where those values are actually available.

The below shows that XYZ is missing market data from T-n to T-3. For those values, a proxy may be created using SPX & IXT returns. XYZ does have market data from T-2 to T, meaning that those values may be used directly.

```
SCENARIO.XYZ {
  PROXY_RETURN = 0.81 * RETURN(SPX) + 1.2 * RETURN(IXT);
  PROXY_SCEN = FUNCTION.EQSPOT.SCENARIOGEN.RELATIVE(
  PROXY_RETURN,XYZ[today]); //scenarios on derived returns
  XYZ_SCEN =
  FUNCTION.EQSPOT.SCENARIOGEN.RELATIVE(RETURN(XYZ),XYZ[today]);
  RES_SCEN = IF( #DATE < 1-Mar-2018, PROXY_SCEN, XYZ_SCEN );
  RETURN RES_SCEN;
}
```

The library functions referred to by the scenario expressions include scenario generator functions. Scenario generator functions may include primitive code to create the scenario objects from historical and today's market data. The library functions may also include library other helper functions, such as functions computing returns, etc.

Scenario generator functions should produce consistent scenario objects that are resilient to wide range of inputs received from historical datasets (or externally modeled datasets). Particularly, scenario generator functions may be able to handle large moves and must be able to handle and correct resulting negative vols, etc. To be able to handle market data corrections, each scenario generator may take todays MDO as an argument. The result of a Scenario Generator Function (“SGF”) is the triple <Scenario, Error, MetaData>. While “Scenario” is an internal pricing object opaque to external components, a human readable string representation may be exposed via the metadata object to aid in reporting and investigations.

The scenario term may be the target shock value that may be applied to the MDO during pricing. Resiliency is achieved by correcting the input scenarios in well-defined and justifiable manners to minimize scenario valuation failures with the corrected shock scenarios. Such corrections are based on methodologies to be developed by quants and MRA and implemented by the quant routines together with MDO_{Today} and corresponding calibration and pricing models. The scenario generators, in accordance with the techniques of this disclosure, may produce scenarios that result in no arbitrage when applied to today's MDOs. This methodology can reduce the number of pricing failures by orders of magnitude.

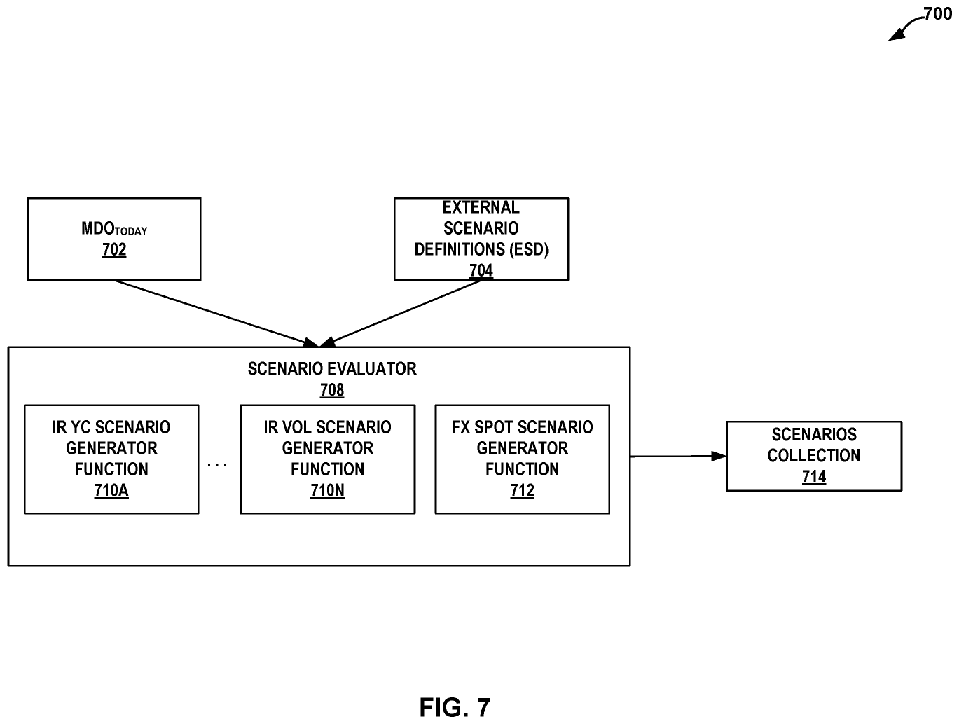

FIG. 7 is a conceptual diagram illustrating an example scenario evaluation process based on external scenario definitions, in accordance with the techniques of this disclosure. In contrast to VaR, in CCAR/Stress use cases, the shocks would be specified externally and provided as input for calculations. Rather than directly applying the shocks to the MDOs 702 and the resultant shocked MDOs being passed to pricers to generate the required NPVs, the techniques described herein may generate resilient Scenario objects to be used in CCAR/stress calculators. As such, the shocked MDOs are “validated” for correctness, as failing to do so is the leading cause for failures during pricing.

To accommodate this mode of execution, an External Scenario Definitions (“ESD”) 704 is introduced. ESD 704 encapsulates a human-readable) set of instructions with data related to the risk factors and shock returns that need to be applied to the MDOs 702. Scenario evaluator 708 consumes ESD 704 and interprets the directives. For each risk factor specified in ESD 704, it fetches the corresponding MDO_{Today} 702 and delegates the scenario object generation to appropriate MDO 702 specific scenario generator function 710A-710N or 712. Scenario generator functions 710A-710N or 712 use the shock values that were input, along with the corresponding MDO_{Today} objects 702, to ensure “valid” scenarios are generated. The output may be a collection of scenario objects 714.

Referring back to FIG. 1, FIG. 1 provides a view of how the different systems would interact in the proposed solution as the system transition positions' risk/PNL onto the market risk calculation platform. While the fundamental review of the trading book (FRTB) expected shortfall calculator utilizes all components of the VaR calculator, the VaR calculator described herein may also have finer control over the risk factor sets, wherein the shocks for sets of risk factors can be included or excluded, depending on their membership in the following categories. Risk factors may fall under any of a number of risk classes, including interest rates, equity, credit spreads, Forex, and commodity.

One aspect of the shocks for sets of risk factors may include liquidity horizon buckets, or the time taken to liquidate or hedge risk positions during the stress period. These liquidity horizon buckets, for example, could be 10-, 20-, 40-, 60-, or 120-days, or even longer in some instances. In some instances, a reduced set of risk factors could be affected by these shocks. A reduced set of risk factors is a subset of risk factors with own time series or accurate proxies during the stress period.

The proposed solution is designed to accommodate these requirements based on the input request attributes which can drive the expected behavior. Expected shortfall is defined in terms of VaR. For a given confidence level γ, ESγ, is the average of all losses at or above the 1−γ loss (i.e., the average of all losses at or above VaRγ). Mathematically, ESγ is given by:

ESγ=E[L|L>VaRγ]

Once VaRγ is obtained, ES can be trivially computed by taking the all the loss values greater than the VaR value and computing their average.

VaR is defined in terms of the loss, L, of the portfolio. For instance, for a given confidence level, γ (expressed as a percentage), VaRγ is the loss value such 1−γ of the potential losses in the distribution are at or above VaRγ. Mathematically, VaRγ is given by:

P[L≥VaRγ]=1−γ

where P[ ] is the probability indicator function.

If the risk horizon defining the risk factor change has n days, the corresponding VaR is usually referred to as n-day VaR. The most common examples of n-day VaR are 1-day VaR and 10-day VaR. VaR is taken as the percentile point of the distribution depending on the confidence interval assumed. For example, a 95% VaR may be the 5-percentile of the simulated distribution, and 99% VaR may be the 1-percentile of the distribution. The simulated PNL vector is generated in the pricing step and it represents the distribution from which VaR can be computed. For instance, for 251-day historic PNL return vectors, the 99% VaR would correspond to the second biggest loss in the 251 PNL values, as the 1-percentile of the distribution corresponds to:

floor(251*1%)=2

At the portfolio or node level, VaR is not additive. Instead, VaR is calculated after the aggregated PNL vector is available for a node in the portfolio hierarchy. PNL vectors are additive and can be simply aggregated to the node level by taking the individual positions' PNL vectors under that node. By having the portfolio hierarchy and the granular position level PNL vectors, the techniques described herein can aggregate the PNL vectors to the node of interest and produce the VaR in a straightforward manner.

Thus, for all of the positions and PNL vectors computed in market risk calculation platform 102, the techniques described herein may also generate the standalone VaR number in market risk calculation platform 102, which may be used in development and investigation purposes. The generated PNL vectors may be shipped to the aggregation and reporting unit 106 for all official reporting purposes.

What-if analysis aims to assess the VaR impact due to a hypothetical change in one or more inputs to VaR calculators. While this may be used for several purposes, a first use case is to analyze position change, or to view VaR impact of making a trade in a portfolio (i.e., change in portfolio positions). What-if analysis may also be used to analyze time series change, or to view VaR impact of correction of historical market data. In other words, what-if analysis analyzes the change to a value(s) of a particular timeseries for a specific date(s) in past. For time series modeling, what-if analysis may create new timeseries by taking different multiple underlying timeseries, or for weight (re)allocation of derived timeseries for different periods. What-if analysis may also be used for data quality analysis, such as the assessment of quality of timeseries from different vendors. What-if analysis may further be used to monitor VaR model changes, such as assessing the impact of new waterfall mechanisms for VaR generation for a certain asset class. Another example of a use case for what-is analysis is the development of new models for onboarding new products.

The following describes a use case of a VaR impact assessment due to a position change in the portfolio. Initially, it may be assumed that the hypothetical position, along with corresponding market data and risk factor time series, are available in market risk calculation platform 102. The standalone VaR for this individual hypothetical position may be obtained in a straightforward manner by computing its PNL vector over the lookback period. However, to assess the impact of the new position on the firm-wide VaR or at a certain node of portfolio hierarchy, the PNL distribution may be determined at its respective node hierarchy.

If the node's underlying position PNL vectors were generated in market risk calculation platform 102, the techniques described herein would pick up the previous EOD aggregated PNL vector, add the new PNL vector corresponding to the new position and compute VaR on the resultant PNL vector. The techniques described herein may tap into intraday present values (“PVs”).

The pricing module may be responsible for generating the final PNL vectors across different time periods, the VaR, SVaR, and other values along with specified risk horizon (1d, 10d, etc.) for both full revaluation and for sensitivity based approaches. This component relies extensively on the pricing framework in market risk calculation platform 102 and its underlying pricing models. Specifically, this step constitutes creation of “VaR Pricing Tasks.” VaR pricing tasks may include creating the ShockedMDO using base MDO_{Today} and scenario objects, pricing the instruments using the pricers and/or proxy pricers, and handling partial or complete failure scenarios.

Proxy pricers and other programmed pricers may be used identically to supplement the pricing behavior in order to satisfy different VaR calculation use cases. For instance, proxy pricers may be used when programmed pricers are not fast enough, as well as for mimicking legacy VaR behavior.

When designing pricers, programmed pricers should have the capability of producing a risk pricer. Both proxy pricers and programmed pricers should be identically packaged (both implementing “risk pricer” interface) so that they are interchangeable. The default risk pricer may be the programmed pricer. Examples of such pricers include the Delta gamma approximator and the American Monte Carlo approximator.

This pricing module should be scalable and performant for full revaluation calculations. The VaR pricing tasks created should seamlessly integrate with any distribution and batching strategies that may be developed in the framework to optimally use the compute infrastructure (e.g. instrument pricing cost based batching, CCY based batching, MDO set based batching, etc.). The final result set should also include information gathered across all the run steps, providing complete transparency of the context and the parameters used in generating the result.

In one example of implementing the scenario expressions described herein, a use case is provided using a heterogeneous data set available for different historic periods. Let RFUSDPAR represent the risk factor In this example, the YC.USD.LIBOR.3M.ParRate.LinearInterp@1D RFUSDFWD1D time series expression definition may be:
<20070101, 20100312, RFUSDFWD1D>=MOVAVG(FixlmplyFwd(RFUSDPAR), 20)+0.02;
<20100313,*, RFUSDFWD1D>=RFUSDFWD1D;

The RFUSDFWD1D between time period 20070101-20100312 may be constructed by adding a 0.02 basis over 20-day-movingavg-of-derived-forward-rates(using par rates), and, for time period 20100313—Present, the pricing module may directly source the available RFUSDFWD1D timeseries from a data repository.

In one example of implementing the scenario expressions described herein, a use case is provided using missing data due to regional holidays, etc. In this example, the RFUSDFWD1D time series expression definition may be:
<*,*, RFUSDFWD1D>=FWDFILL(TSLookup(“DF”, RFUSDFWD1D))// use previous available value and forward fill the value for missing date.
<*,*, RFUSDFWD1D>=FIXINTERPFILL (TSLookup(“DF”, RFUSDFWD1D), “Linear”) //use quant library linear interpolation to imply missing points.

In another example of implementing the scenario expressions described herein, a use case is provided using proxy definitions that can be trivially formulated by the timeseries expressions.
<20070101, 20170303, XYZ>=TSLookup(“DF”, “S&P500”) //proxy to S&P500
<20070304, *, XYZ>=TSLookup(“DF”, “XYZ”)

In another example of implementing the scenario expressions described herein, a use case is provided using heterogeneous sets of data due to different model usage during different time periods, which is a more involved use case. Here, it is assumed that a bank has volume marks based on a volatility model until 20110303, when the models switched to use Heston models and started marking the volatililty surface points based on the new model. In this example, the USDVOL.HESTON timeseries expressions may include:
<20070101, 20110303, USDVOL.HESTON>=ConvertSABR_TO_HESTON(TSLookup(“DF”, “USDVOL.SABR”))
<20110304, *, USDVOL.HESTON>=TSLookup(“DF”, “USDVOL.HESTON”))

Here, the ConvertSABR_TO_HESTON( )function is defined by QR (in the platform), ensuring the re-generated points are consistent with the models.

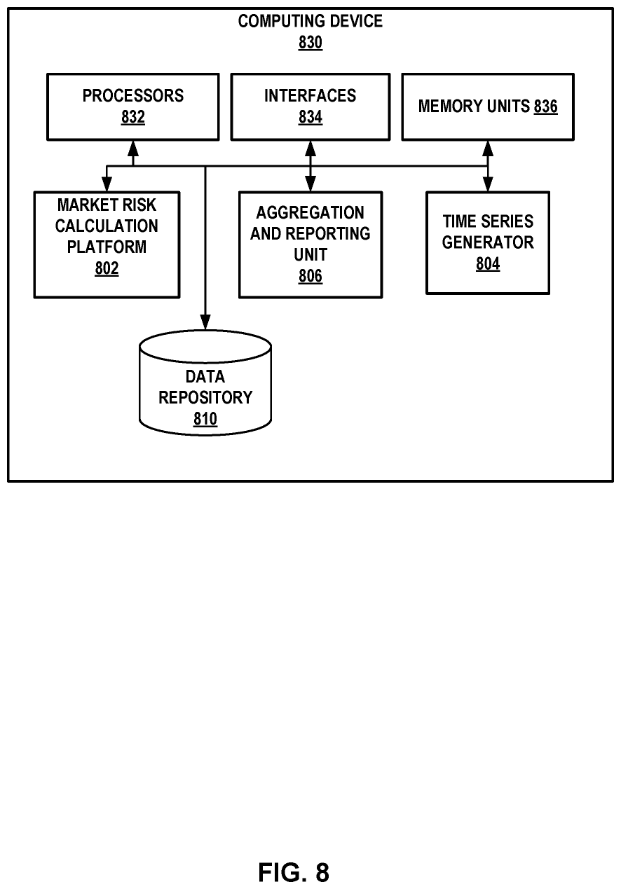

FIG. 8 is a block diagram illustrating an example computing device 830 that includes market risk calculation platform 802, which is an example of market risk calculation platform 102 from FIG. 1 or market risk calculation platform 202 from FIG. 2, in accordance with the techniques of this disclosure. As described above, computing device 830. The architecture of computing device 830 illustrated in FIG. 8 is shown for exemplary purposes only. Computing device 830 should not be limited to the illustrated example architecture. In other examples, computing device 830 may be configured in a variety of ways. For instance, although computing device 830 is illustrated in a single computing device in the example of FIG. 8, in other examples, functional units may be executed on a centralized or distributed network of computing devices.

As shown in the example of FIG. 8, computing device 830 includes one or more processors 832, one or more interfaces 834, one or more memory units 836, and data repository 810. Computing device 830 also includes market risk calculation platform 802, time series generator 804, and aggregation and reporting unit 806, which may be implemented as program instructions and/or data stored in memory units 836 and executable by processors 832 or implemented as one or more hardware units or devices of computing device 830. Memory units 836 of computing device 830 may also store an operating system (not shown) executable by processors 832 to control the operation of components of computing device 830. The components, units or modules of computing device 830 are coupled (physically, communicatively, and/or operatively) using communication channels for inter-component communications. In some examples, the communication channels may include a system bus, a network connection, an inter-process communication data structure, or any other method for communicating data.

In the example of FIG. 8, time series generator 804 and aggregation and reporting unit 806 are shown as part of the same computing device 830 that includes market risk calculation platform 802. However, in other examples, time series generator 804 and/or aggregation and reporting unit 806 may be located in a different computing device that is separate from computing device 830. In such instances, market risk calculation platform 802 may leverage interfaces 834 to receive the data produced by time series generator 804 and/or aggregation and reporting unit 806 needed to generate valid scenario objects. Market risk calculation platform 802 may further leverage interfaces 834 to send data associated with valid scenario objects to time series generator 804 and/or aggregation and reporting unit 806 in examples where time series generator 804 and/or aggregation and reporting unit 806 are located outside of computing device 830.

Processors 832, in one example, may comprise one or more processors that are configured to implement functionality and/or process instructions for execution within computing device 830. For example, processors 832 may be capable of processing instructions stored by memory units 836. Processors 832 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory units 836 may be configured to store information within computing device 30 during operation. Memory units 836 may include a computer-readable storage medium or computer-readable storage device. In some examples, memory units 836 include one or more of a short-term memory or a long-term memory. Memory units 36 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory units 836 are used to store program instructions for execution by processors 832. Memory units 836 may be used by software or applications running on computing device 830 (e.g., market risk calculation platform 802) to temporarily store information during program execution.

Computing device 830 may utilize interfaces 834 to communicate with external devices via one or more networks. Interfaces 834 may be network interfaces, such as Ethernet interfaces, optical transceivers, radio frequency (RF) transceivers, or any other type of devices that can send and receive information. Other examples of such network interfaces may include Wi-Fi or Bluetooth radios. In some examples, computing device 830 utilizes interfaces 834 to wirelessly communicate with external devices.

According to the disclosed techniques, market risk calculation platform 802 generates a scenario object that includes an adjustment to a current market data object. In some instances, market risk calculation platform 802 generates the scenario object based on a historical market data model. In some instances, market risk calculation platform 802 generates the scenario object according to one or more scenario expressions. For example, market risk calculation platform 802 may request historical market data from data repository 810, receive one or more time series conditions, manipulate one or more characteristics of the historical market data based on the one or more time series conditions, and generate the scenario object based on the manipulated historical market data. The one or more time series conditions may include one or more of a data set for a time series, identification of missing data in the time series, proxy definitions for the missing data in the time series, heterogeneous data from different models used to construct the time series, or risk factors for different time periods within the time series. In manipulating the one or more characteristics of the historical data model, market risk calculation platform 802 can define interest rate periods, set default parameters for unavailable past data, calculate averages for unavailable past data, or define replacement data for unavailable past data.

Further, market risk calculation platform 802 may generate the scenario object using a software library of financial instrument evaluation tools, such as a Quant library. In still other instances, market risk calculation platform 802 may generate the scenario object based on the current market data object. For example, market risk calculation platform 802 may receive one or more scenario expressions, a risk factor time series, and the current market data object. After receiving this data, market risk calculation platform 802 may generate the scenario object based on the one or more scenario expressions, the risk factor time series, and the current market data object.

In still other instances, market risk calculation platform 802 may receive an external scenario definition from an external source. In such instances, market risk calculation platform 802 may generate the scenario object based on the external scenario definition and the current market data object.

In some examples, market risk calculation platform 802 may further verify that the scenario object is a valid scenario object. A valid scenario object does not violate one or more arbitrage conditions when applied to the current market data object. Market risk calculation platform 802 may perform this verification step prior to applying the scenario object to a pricing system. For instance, prior to applying the scenario object to the pricing system, market risk calculation platform 802 may determine whether the scenario object violates the one or more arbitrage conditions. If market risk calculation platform 802 determines that the scenario object does not violate the one or more arbitrage conditions, market risk calculation platform 802 may determine that the scenario object is the valid scenario object. Conversely, responsive to determining that the scenario object violates the one or more arbitrage conditions, market risk calculation platform 802 applies one or more adjustments to the historical market data model based on the one or more arbitrage conditions violated by the scenario object. Market risk calculation platform 802 then generates the valid scenario object that includes a second adjustment to the current market data based on the adjusted historical market data model. In applying the one or more adjustments to the historical market data model, market risk calculation platform 802 applies one or more minimum adjustments to the historical market data model such that the valid scenario object does not violate the one or more arbitrage conditions.

Upon generating the scenario object, or the valid scenario object if the verification process is performed, market risk calculation platform 802 calculates an adjusted market data object by applying the scenario object to the current market data object. Using the adjusted market data object, market risk calculation platform 802 may calculate additional data to be used in risk evaluation, such as a market risk value or a capital requirement, using pricers that could include one or more of a Greeks computation, a credit valuation adjustment, a polarized fractal efficiency, a value at risk quantile, a comprehensive capital analysis and review, a stress report, or a trader slide. Market risk calculation platform 802 may also send the adjusted market data object to an external pricing system, which calculates the market risk value or the capital value.

In some examples, market risk calculation platform 802 may further receive one or more risk factors for each time period within the time series. Market risk calculation platform 802 may then calculate one or more returns based on the risk factors. These one or more returns can include relative returns, absolute returns, or custom returns including a combination of a relative return and an absolute return for a particular time period within the time series.

After applying the scenario object to the current market data object, market risk calculation platform 802, in some instances, may generate, according to one or more updated scenario expressions executed by market risk calculation platform 802, an updated scenario object. In generating the updated scenario object according to the one or more updated scenario expressions, market risk calculation platform 802 receives one or more updates to the one or more time series conditions, manipulates the one or more characteristics of the historical market data based on the updated one or more time series conditions, and generates, based on the manipulated historical market data, an updated scenario object that includes an updated adjustment to the current market data object. Once market risk calculation platform 802 generates the updated scenario object, market risk calculation platform 802 may apply the updated scenario object to the current market data object to calculate an updated adjusted market data object.

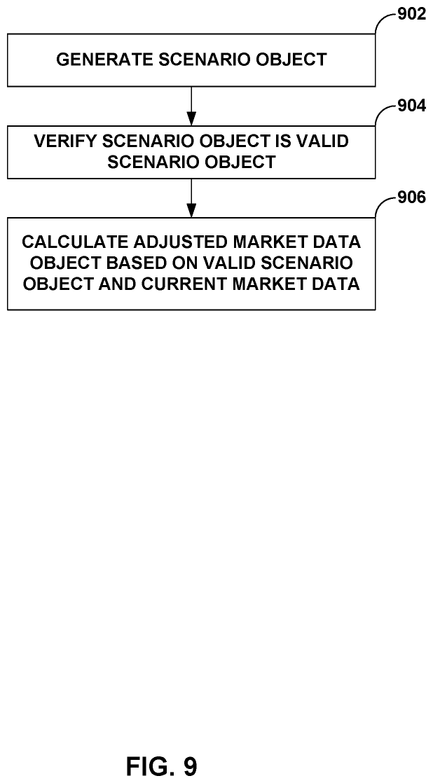

FIG. 9 is a flowchart illustrating a first example operation of a computing device to generate valid scenarios to calculate and report market risk, in accordance with the techniques of this disclosure. The example operation of FIG. 9 is described with respect to market risk calculation platform 202 of FIG. 2.

In accordance with the techniques of this disclosure, market risk calculation platform 202 generates, based on the historical market data model, a scenario object that includes an adjustment to a current market data object (902). Market risk calculation platform 202 verifies that the scenario object comprises a valid scenario object (904). A valid scenario object does not violate one or more arbitrage conditions when applied to the current market data object. Upon generating the valid scenario object, market risk calculation platform 202 calculates an adjusted market data object based on the valid scenario object and the current market data object (906).

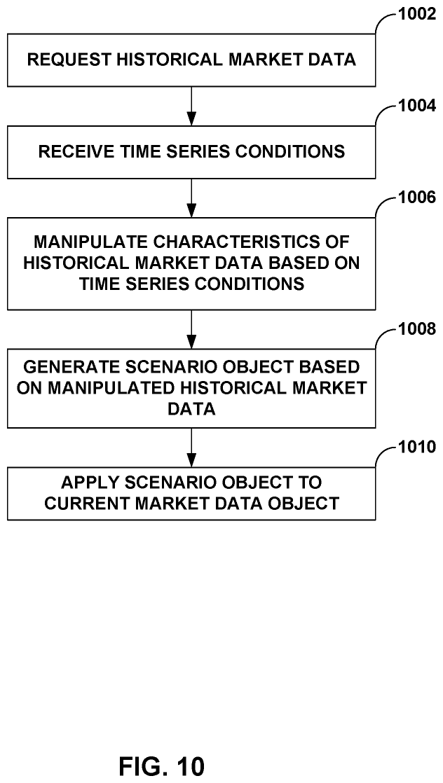

FIG. 10 is a flowchart illustrating a second example operation of a computing device to generate valid scenarios to calculate and report market risk, in accordance with the techniques of this disclosure. The example operation of FIG. 10 is described with respect to market risk calculation platform 202 of FIG. 2.

In accordance with the techniques of this disclosure, market risk calculation platform 202 requests the historical market data from the memory (1002). Market risk calculation platform 202 receives one or more time series conditions (1004). Market risk calculation platform 202 manipulates one or more characteristics of the historical market data based on the one or more time series conditions (1006). Based on the manipulated historical market data, market risk calculation platform 202 generates the scenario object (1008). Market risk calculation platform 202 then applies the scenario object to the current market data object to calculate an adjusted market data object (1010).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Techniques of this disclosure may provide one or more technical advantages. For example, analyzing social-network data 104, including page-view data, page-content data, and relationship data, may allow for more accurately predicting likelihood of a spear-phishing attempt. This more accurate prediction may also allow for more effective prevention of spear-phishing attempts, which may result in reduction in lost resources, including human, capital, and technological resources that may be compromised by successful spear-phishing attempts and/or needed for responding to a successful spear-phishing attempt. More efficient analysis and prevention may result in reduced computer processing and storage resources needed as a result of a spear-phishing attempt.

Various examples have been described. These and other examples are within the scope of the following claims.

1. A method comprising:
generating, by a computing device and based on a historical market data model, a scenario object comprising an adjustment to a current market data object, wherein the scenario object comprises data having attributes and behavior that simulates market moves based on the historical market data model;
prior to applying the scenario object to a pricing system, verifying, by the computing device, whether the scenario object comprises a valid scenario object that will not cause a failure at the pricing system, wherein the valid scenario object does not violate one or more arbitrage conditions when applied to the current market data object;
when the scenario object is not verified as a valid scenario object:
adjusting, by the computing device, the historical market data model to apply corrections to the scenario object until the scenario object is verified as the valid scenario object, and
recording, by the computing device, metadata associated with the scenario object that identifies the corrections made to the scenario object to produce the valid scenario object;
in response to verifying that the scenario object is the valid scenario object, applying, by the computing device, the valid scenario object as input to the pricing system to calculate an adjusted market data object based on the valid scenario object and the current market data object;
sending, by the computing device, the adjusted market data object to one or more pricing calculators to calculate a market risk value for financial assets; and
reporting, by the computing device, the market risk value for the financial assets to a regulatory body.

2. The method of claim 1, wherein the scenario object is a first scenario object comprising a first adjustment to the current market data object,
wherein verifying whether the first scenario object comprises the valid scenario object comprises:
determining, by the computing device, whether the first scenario object violates the one or more arbitrage conditions when applied to the current market data object; and
wherein adjusting the historical market data model comprises, responsive to determining that the first scenario object violates the one or more arbitrage conditions when applied to the current market data object:
applying, by the computing device, one or more adjustments to the historical market data model based on the one or more arbitrage conditions violated by the first scenario object; and
generating, by the computing device and based on the adjusted historical market data model, the valid scenario object comprising a second adjustment to the current market data object.

3-4. (canceled)

5. The method of claim 1, wherein generating the scenario object comprises generating the scenario object using a software library of financial instrument evaluation tools.

6. (canceled)

7. The method of claim 1, wherein generating the scenario object comprises:
receiving, by the computing device, one or more scenario expressions;
receiving, by the computing device, a risk factor time series;
receiving, by the computing device, the current market data object; and
generating, by the computing device, the scenario object based on the one or more scenario expressions, the risk factor time series, and the current market data object.

8. The method of claim 1, wherein generating the scenario object comprises:
receiving, by the computing device, an external scenario definition from an external source;
receiving, by the computing device, the current market data object; and
generating, by the computing device, the scenario object based on the external scenario definition and the current market data object.

9. A computing device comprising:
a memory configured to store at least historical market data; and
one or more processors in communication with the memory and configured to:
generate, based on the historical market data model, a scenario object comprising an adjustment to a current market data object, wherein the scenario object comprises data having attributes and behavior that simulates market moves based on the historical market data model;
prior to applying the scenario object to a pricing system, verify whether the scenario object comprises a valid scenario object that will not cause a failure at the pricing system, wherein the valid scenario object does not violate one or more arbitrage conditions when applied to the current market data object;
when the scenario object is not verified as a valid scenario object:
adjust the historical market data model to apply corrections to the scenario object until the scenario object is verified as the valid scenario object, and
record metadata associated with the scenario object that identifies the corrections made to the scenario object to produce the valid scenario object;
in response to verifying that the scenario object is the valid scenario object, apply the valid scenario object as input to the pricing system to calculate an adjusted market data object based on the valid scenario object and the current market data object; and
send the adjusted market data object to one or more pricing calculators to calculate a market risk value for financial assets; and
report the market risk value for the financial assets to a regulatory body.

10. The computing device of claim 9, wherein the scenario object is a first scenario object comprising a first adjustment to the current market data object,
wherein the one or more processors being configured to verify whether the first scenario object comprises the valid scenario object comprises the one or more processors being configured to:
determine whether the first scenario object violates the one or more arbitrage conditions when applied to the current market data object; and
wherein the one or more processors being configured to adjust the historical market data model comprises the one of more processors being configured to, responsive to determining that the first scenario object violates the one or more arbitrage conditions when applied to the current market data object:
apply one or more adjustments to the historical market data model based on the one or more arbitrage conditions violated by the first scenario object; and
generate, based on the adjusted historical market data model, the valid scenario object comprising a second adjustment to the current market data object.

11-12. (canceled).

13. The computing device of claim 9, wherein the one or more processors being configured to generate the scenario object comprises the one or more processors being configured to generate the scenario object using a software library of financial instrument evaluation tools.

14. (canceled)

15. The computing device of claim 9, wherein the one or more processors being configured to generate the scenario object comprises the one or more processors being configured to:
receive one or more scenario expressions;
receive a risk factor time series;
receive the current market data object; and
generate the scenario object based on the one or more scenario expressions, the risk factor time series, and the current market data object.

16. The computing device of claim 9, wherein the one or more processors being configured to generate the scenario object comprises the one or more processors being configured to:
receive an external scenario definition from an external source;
receive the current market data object; and
generate the scenario object based on the external scenario definition and the current market data object.

17. A non-transitory computer-readable storage medium comprising instructions that, when executed, cause one or more processors of a computing device to:
generate, based on historical market data model, a scenario object comprising an adjustment to a current market data object, wherein the scenario object comprises data having attributes and behavior that simulates market moves based on the historical market data model;
prior to applying the scenario object to a pricing system, verify whether the scenario object comprises a valid scenario object that will not cause a failure at the pricing system, wherein the valid scenario object does not violate one or more arbitrage conditions when applied to the current market data object;
when the scenario object is not verified as a valid scenario object:
adjust the historical market data model to apply corrections to the scenario object until the scenario object is verified as the valid scenario object, and
record metadata associated with the scenario object that identifies the corrections made to the scenario object to produce the valid scenario object;
in response to verifying that the scenario object is the valid scenario object, apply the valid scenario object as input to the pricing system to calculate an adjusted market data object based on the valid scenario object and the current market data object; and
send the adjusted market data object to one or more pricing calculators to calculate a market risk value for financial assets; and
report the market risk value for the financial assets to a regulatory body.

18. The non-transitory computer-readable storage medium of claim 17, wherein the scenario object is a first scenario object comprising a first adjustment to the current market data object,
wherein instructions that cause the one or more processors to verify whether the first scenario object comprises the valid scenario object comprises instructions that, when executed, cause the one or more processors to:
determine whether the first scenario object violates the one or more arbitrage conditions when applied to the current market data object; and
wherein instructions that cause the one or more processors to adjust the historical market data comprises instructions that, when executed, cause the one or more processors to, responsive to determining that the first scenario object violates the one or more arbitrage conditions when applied to the current market data object:
apply one or more adjustments to the historical market data model based on the one or more arbitrage conditions violated by the first scenario object; and
generate, based on the adjusted historical market data model, the valid scenario object comprising a second adjustment to the current market data object.

19. (canceled)

20. The non-transitory computer-readable storage medium of claim 17, wherein instructions that cause the one or more processors to generate the scenario object comprises instructions that, when executed, cause the one or more processors to:
receive an external scenario definition from an external source;
receive the current market data object; and
generate the scenario object based on the external scenario definition and the current market data object.

21. The method of claim 1, wherein reporting the market risk value to the regulatory body includes reporting at least a portion of the metadata associated with the valid scenario object, wherein the metadata comprises information that identifies one or more arbitrage violations encountered during a scenario object validation process and the corrections made to the scenario object to avoid the one or more arbitrage violations and produce the valid scenario object.

22. The computing device of claim 9, wherein to report the market risk value to the regulatory body, the one or more processors are configured to report at least a portion of the metadata associated with the valid scenario object, wherein the metadata comprises information that identifies one or more arbitrage violations encountered during a scenario object validation process and the corrections made to the scenario object to avoid the one or more arbitrage violations and produce the valid scenario object.

23. The non-transitory computer-readable storage medium of claim 17, wherein the instructions that cause the one or more processors to report the market risk value to the regulatory body comprise instructions that further cause the one or more processors to report at least a portion of the metadata associated with the valid scenario object, wherein the metadata comprises information that identifies one or more arbitrage violations encountered during a scenario object validation process and the corrections made to the scenario object to avoid the one or more arbitrage violations and produce the valid scenario object.
